(19) United States
(12) Patent Application Publication
(10) Pub. No.: US 2025/0290831 A1
(43) Pub. Date: Sep. 18, 2025

(54) MONITORING DEVICE, DISPLAY METHOD AND PROGRAM

(71) Applicant: MITSUBISHI SHIPBUILDING CO., LTD., Tokyo (JP)

(72) Inventors: Shunsaku MATSUMOTO, Tokyo (JP); Keisuke TSUKAHARA, Tokyo (JP); Tadashi SUGIMURA, Tokyo (JP); Shin TERADA, Yokohama-shi (JP); Satoshi MIYAZAKI, Yokohama-shi (JP)

(21) Appl. No.: 18/861,217

(22) PCT Filed: Mar. 14, 2023
(86) PCT No.: PCT/JP2023/009754

§ 371 Date: Oct. 29, 2024

(30) Foreign Application Priority Data
May 13, 2022 (JP) 2022-079232

(51) Int. Cl. G01M 99/00; G06T 11/20

(52) U.S. Cl. CPC G01M 99/00; G06T 11/206

(57) ABSTRACT

Provided is a monitoring device that can output a damage probability of a monitoring target or the like. The monitoring device includes: a sensor information acquisition unit configured to acquire sensor information measured by a sensor; a damage level and failure probability evaluation unit configured to calculate a failure probability and a damage level per part or device constituting an evaluation target by using the sensor information; and a display control unit configured to display the sensor information and the failure probability or the damage level of the part or the device.

### TECHNICAL FIELD

The present disclosure relates to a monitoring device, a display method, and a program. The present disclosure claims priority based on JP 2022-079232 filed in Japan on May 13, 2022, the contents of which are incorporated herein by reference.

### BACKGROUND ART

An industrial machine is provided with many sensors, and a large amount of various sensor information is generated from the sensors. In particular, it is important to acquire sensor information indicating operation characteristics of a machine, and it is widespread practice to update a digital model of an industrial machine built in a cyber space using the sensor information or to monitor or analyze the industrial machine using data obtained from the digital model. Patent Document 1 discloses a system that acquires sensor information indicating operation characteristics from a machine included in an oil gas production facility and generates a digital model of the machine based on a user input through a graphical user interface (GUI). Patent Document 2 discloses an interactive monitoring system that visually displays an output value of a digital model of a machine of an oil gas production facility.

### CITATION LIST

### Patent Literature

Patent Document 1: U.S. Pat. No. 10,884,402
Patent Document 2: U.S. Pat. No. 10,746,015

### SUMMARY OF INVENTION

### Technical Problem

In monitoring an industrial machine, a plant, or the like, information such as a failure probability or a damage level is required in addition to obtaining sensor information to observe a state of a target. Patent Documents 1 and 2 do not disclose a function of analyzing and outputting such information.

The present disclosure provides a monitoring device, a display method, and a program that can solve the above-described problem.

### Solution to Problem

According to an aspect of the present disclosure, a monitoring device includes: a sensor information acquisition unit configured to acquire sensor information measured by a sensor; a damage level and failure probability evaluation unit configured to calculate a failure probability or a damage level per part or device constituting an evaluation target by using the sensor information; and a display control unit configured to display the sensor information and the failure probability or the damage level of the part or the device.

According to an aspect of the present disclosure, a display method includes: a step of acquiring sensor information measured by a sensor; a step of calculating a failure probability or a damage level per part or device constituting an evaluation target by using the sensor information; and a step of displaying the sensor information and the failure probability or the damage level of the part or the device.

According to an aspect of the present disclosure, a program causes a computer to execute: a step of acquiring sensor information measured by a sensor; a step of calculating a failure probability or a damage level per part or device constituting an evaluation target by using the sensor information; and a step of displaying the sensor information and the failure probability or the damage level of the part or the device.

### Advantageous Effects of Invention

The monitoring device, the display method, and the program described above allows a failure probability or a damage level to be calculated and the calculated failure probability or the calculated damage level to be output.

### BRIEF DESCRIPTION OF DRAWINGS

FIG. 1 is a diagram illustrating an example of a monitoring device according to an embodiment.

FIG. 2 is a diagram illustrating an operation example of the monitoring device according to the embodiment.

FIG. 3 is a first diagram illustrating an example of operation measure evaluation according to the embodiment.

FIG. 4 is a first diagram illustrating an example of maintenance measure evaluation according to the embodiment.

FIG. 5 is a second diagram illustrating an example of the maintenance measure evaluation according to the embodiment.

FIG. 6 is a third diagram illustrating an example of the maintenance measure evaluation according to the embodiment.

FIG. 7 is a fourth diagram illustrating an example of the maintenance measure evaluation according to the embodiment.

FIG. 8 is a second diagram illustrating an example of the operation measure evaluation according to the embodiment.

FIG. 9 is a first diagram illustrating a layout example of a monitoring screen according to the embodiment.

FIG. 10 is a second diagram illustrating a layout example of the monitoring screen according to the embodiment.

FIG. 11 is a third diagram illustrating a layout example of the monitoring screen according to the embodiment.

FIG. 12 is a fourth diagram illustrating a layout example of the monitoring screen according to the embodiment.

FIG. 13A is a first diagram illustrating an example of an insight screen according to the embodiment.

FIG. 13B is a second diagram illustrating an example of the insight screen according to the embodiment.

FIG. 13C is a third diagram illustrating an example of the insight screen according to the embodiment.

FIG. 14A is a first diagram illustrating an example of a risk analysis screen (overview) according to the embodiment.

FIG. 14B is a second diagram illustrating an example of the risk analysis screen (overview) according to the embodiment.

FIG. 14C is a third diagram illustrating an example of the risk analysis screen (overview) according to the embodiment.

FIG. 15A is a first diagram illustrating an example of a risk analysis screen (individual) according to the embodiment.

FIG. 15B is a second diagram illustrating an example of the risk analysis screen (individual) according to the embodiment.

FIG. 15C is a third diagram illustrating an example of the risk analysis screen (individual) according to the embodiment.

FIG. 16 is a diagram illustrating an example of a sensor information screen according to the embodiment.

FIG. 17 is a diagram illustrating an example of a hardware configuration of the monitoring device according to the embodiment.

### DESCRIPTION OF EMBODIMENTS

### First Embodiment

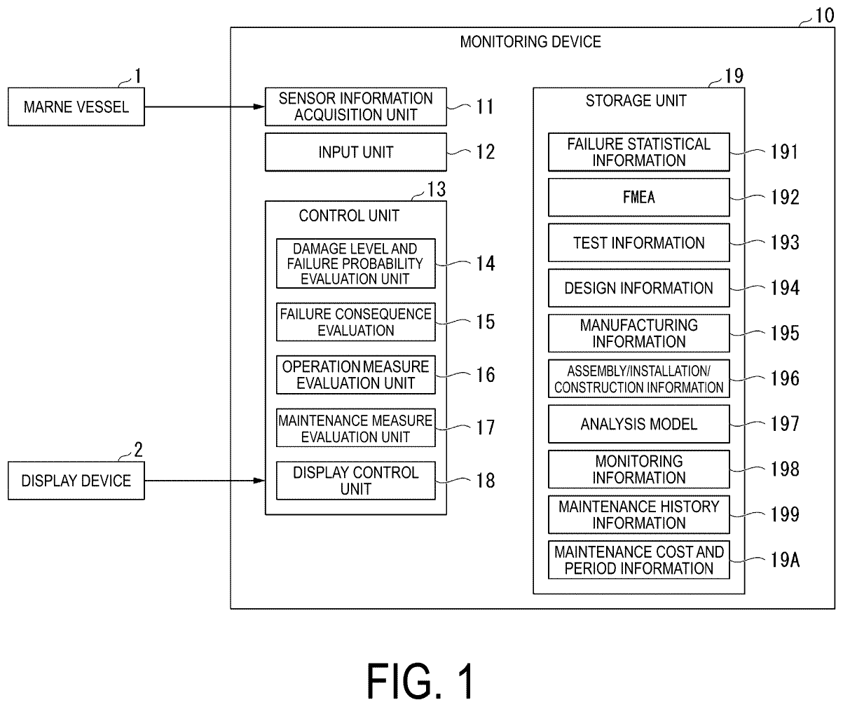

Hereinafter, a monitoring device 10 according to an embodiment of the present disclosure will be described with reference to FIG. 1 to FIG. 17.

### Configuration

FIG. 1 is a diagram illustrating an example of a monitoring device according to the embodiment. The monitoring device 10 acquires and accumulates measurement values (referred to as sensor information) output by various sensors provided in a machine or equipment to be monitored, and calculates and displays information such as a failure probability of the target machine or the target equipment, a consequence degree of a failure, and measures against them. The machine or equipment to be monitored is not limited, and the monitoring device 10 can be used for monitoring of or risk management of a turbine, a compressor, a boiler, a marine vessel, an aircraft, a vehicle, a power generation plant, a chemical plant, or the like. Hereinafter, a case in which a marine vessel 1 is a monitoring target will be described as an example. The marine vessel 1 is, for example, a marine structure such as a marine vessel that navigates on the ocean, a Floating Production, Storage and Offloading system (FPSO), or a Floating Storage and Offloading system (FSO). The marine structure includes not only a main body but also a mooring chain, a pile, and the like for mooring the marine structure. As illustrated in the drawings, the monitoring device 10 includes a sensor information acquisition unit 11, an input unit 12, a control unit 13, and a storage unit 19.

The sensor information acquisition unit 11 acquires sensor information measured by various sensors provided in marine vessel 1 such as an acceleration sensor, a strain sensor, a wave radar, a thickness measurement sensor, a global positioning system (GPS) receiver, a global navigation satellite system (GNSS) receiver, a flow rate sensor, a pressure sensor, a temperature sensor, a rotational speed sensor provided in an engine room, and an inclination sensor of a mooring chain, and records the sensor information in the storage unit 19 in association with measurement times. The sensor information acquisition unit 11 also acquires values calculated using measurement values from the various sensors, information on wave forecast, and the like. The input unit 12 is configured by using an input device such as a keyboard, a mouse, a touch panel, or a button, and receives an input by a user using the input device. For example, the input unit 12 receives an operation of pressing a button, an operation of selecting a display item, and the like on various monitoring screens to be described below.

The control unit 13 controls processing of calculating and outputting information such as evaluation of a failure probability, evaluation of a consequence degree at the time of failure, and measures against them by using a damage level and failure probability evaluation unit 14 to a display control unit 18 to be described below. The control unit 13 includes the damage level and failure probability evaluation unit 14, a failure consequence evaluation unit 15, an operation measure evaluation unit 16, a maintenance measure evaluation unit 17, and the display control unit 18. The damage level and failure probability evaluation unit 14 calculates a failure probability (breakage indicates that a device or the like is broken down due to crack propagation, corrosion, wear, or the like) of each part or each device constituting the marine vessel 1 or a failure probability of each device (failure indicates a state in which the device does not operate normally, a poor functional state of the device, or the like), and a damage level. The failure consequence evaluation unit 15 calculates a consequence degree when a part or a device of the marine vessel 1 is broken or fails (hereinafter, an expression like a consequence degree “at the time of failure” includes a consequence degree “at the time of breakage” as well as “at the time of failure”). The failure consequence evaluation unit 15 can calculate a consequence degree from the viewpoint of cost (for example, for a repairing cost), security (for example, influence on people on the marine vessel 1), an influence on environment (for example, an influence when oil flows out to the ocean), and manufacturing and production (for example, when the marine vessel 1 is an FPSO where petroleum oil is produced, a degree of influence of the breakage of a part or a device of the marine vessel 1 on petroleum oil production). The operation measure evaluation unit 16 calculates an operation measure that reduces damages of the marine vessel 1. For example, the operation measure evaluation unit 16 calculates an operation method (the operation method is an example of an operation measure) of the marine vessel 1 for avoiding breakage or failure of a part having a high failure probability or a part having a large consequence degree at the time of failure based on a failure probability and a damage level calculated by the damage level and failure probability evaluation unit 14 and a consequence degree calculated by the failure consequence evaluation unit 15. The maintenance measure evaluation unit 17 calculates a maintenance measure for the marine vessel 1. For example, the maintenance measure evaluation unit 17 calculates a timing or a cycle of efficient maintenance (the timing or the cycle of maintenance is an example of a maintenance measure) for a part having a high failure probability or a part having a large consequence degree at the time of failure. The control unit 13 performs a final evaluation based on interim evaluation of the failure probability, the damage level, the consequence degree, the operation measure, the maintenance measure, and the like. Then, the final evaluation (an operation measure, a maintenance measure, and the like according to operation and maintenance (O&M) conditions) and the interim evaluation (the calculated failure probability, the calculated damage level, and the calculated consequence degree, and data of the calculation process of the operation measure and the maintenance measure) are output in a graph or the like using the display control unit 18. By displaying the operation measure and the maintenance measure according to the O&M conditions together with the interim evaluation, the basis of the final evaluation can be presented to a user. The control unit records a value obtained by processing the sensor information acquired by the sensor information acquisition unit 11 in the storage unit 19. For example, the control unit 13 may calculate a horizontal bending moment from measurement values on starboard and port sides from strain sensors and record the horizontal bending moment in the storage unit 19.

The display control unit 18 generates a monitoring screen (image) including information such as sensor information of the marine vessel 1 (for example, the latest sensor information acquired), transition of the sensor information accumulated over a predetermined period, a damage level accumulated in each part of the marine vessel 1 indicated by the sensor information, a failure probability, a consequence degree from various viewpoints at the time of breakage and failure, an operation measure, and a maintenance measure, and displays the monitoring screen on the display device 2.

The storage unit 19 stores failure statistical information 191, an FMEA 192, test information 193, design information 194, manufacturing information 195, assembly/installation/construction information 196, an analysis model 197, monitoring information 198, maintenance history information 199, maintenance cost and period information 19A, user information, and the like. The failure statistical information 191 includes a failure history of the marine vessel 1. The FMEA 192 includes information related to a failure risk calculated through a failure mode and effect analysis (FMEA) performed at the time of designing of the marine vessel 1. The test information 193 includes information on various tests performed on the marine vessel 1. The design information 194 includes design information of the marine vessel 1. The manufacturing information 195 includes information indicating how the marine vessel 1 has been manufactured. The assembly/installation/construction information 196 includes information on assembly, installation, and construction for each part or device of the marine vessel 1. The analysis model 197 is a digital model that simulates the structure of the marine vessel 1 using a finite element method (FEM) or the like. The monitoring information 198 includes the sensor information acquired by the sensor information acquisition unit 11. The maintenance history information 199 includes a maintenance history of the marine vessel 1. The maintenance cost and period information 19A includes information on the cost and period required for maintenance of the marine vessel 1. The user information includes information on an account and an authority of a user. In addition, the storage unit 19 stores information defining, for each marine vessel 1, which part and device are to be processed in the processing described below, and which failure mode is to be analyzed for which part and device, and a service life evaluation model, and a corrosion prediction model. The failure mode refers to a type of breakage such as fatigue crack initiation, fatigue crack propagation, corrosion, wear, and the like, and a mode of breakage or failure.

### Operation

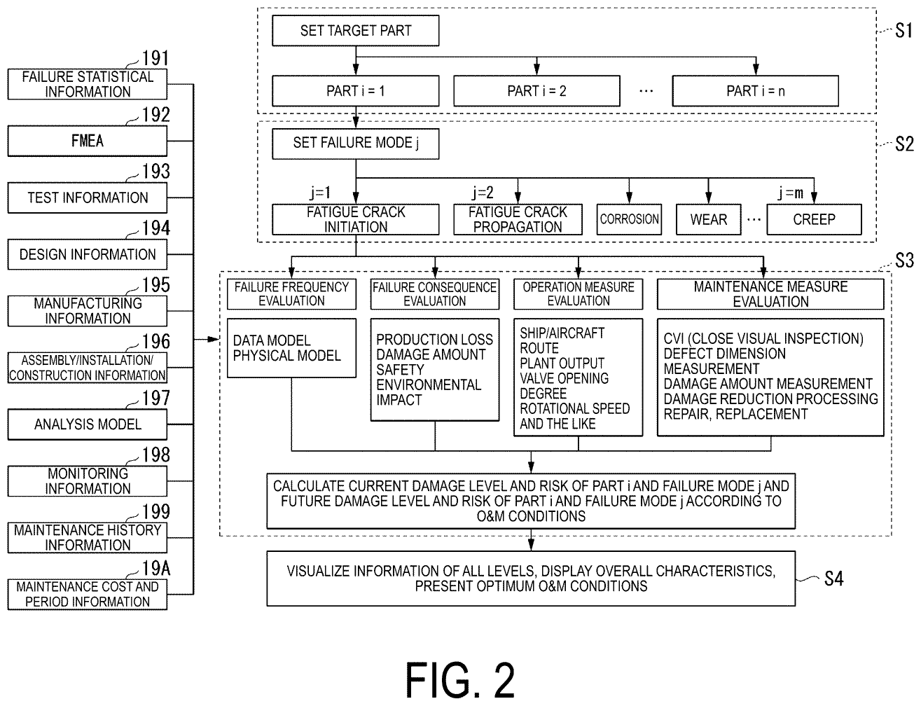

FIG. 2 is a diagram illustrating an operation example of the monitoring device 10 according to the embodiment. For example, when a user designates the marine vessel 1, the input unit 12 acquires identification information of the designated marine vessel and outputs the identification information to the control unit 13. The control unit 13 sets a part i (i=1 to n) to be processed in risk evaluation among parts constituting the marine vessel 1 (step S1). Here, a risk in the risk evaluation is a value obtained by multiplying a failure probability by a consequence degree at the time of failure. The part to be processed may be determined in advance or may be optionally set by the user. A range of the part may be a rough classification such as a bow, a stern, a ship bottom, a port, a starboard, and a bridge, or may be a range obtained by subdividing each of these parts. Instead of or in addition to a part, a device (a pump, an engine, a tank, a turbine, a generator, a propeller, or the like) included in the marine vessel 1 may be set as one part. The control unit 13 sets a part i (i=1 to n) for which a failure probability or the like is to be calculated.

Next, the control unit 13 sets a failure mode j (j=1 to m) for each set part i (step S2). The failure mode j includes fatigue crack initiation, fatigue crack propagation, corrosion, wear, creep, and the like. The failure mode may be determined for each part i, or the user may optionally set what failure mode the part is evaluated for.

Next, the control unit 13 evaluates, for each failure mode j, an occurrence probability of the failure mode j (a failure probability, a failure probability) and/or a damage level, a consequence degree at the time of failure, an operation measure, and a maintenance measure by using the damage level and failure probability evaluation unit 14, the failure consequence evaluation unit 15, the operation measure evaluation unit 16, and the maintenance measure evaluation unit 17. The control unit 13 calculates a damage level and a risk of the part i and the failure mode j at present, and a damage level and a risk of the part i and the failure mode j in the future depending on the operation and maintenance (O&M) conditions (step S3). As described above, the risk is a value obtained by multiplying a failure probability by a consequence degree at the time of failure.

Hereinafter, the details of evaluation processing will be described for cases in which “fatigue crack initiation”, “corrosion”, and “device failure” are taken as examples of the failure mode j. In the following description, the damage level and failure probability evaluation unit 14 performs failure probability evaluation, the failure consequence evaluation unit 15 performs failure consequence evaluation, the operation measure evaluation unit 16 performs operation measure evaluation, and the maintenance measure evaluation unit 17 performs maintenance measure evaluation.

### (1) Fatigue Crack Initiation at Any Structural Part

### (1-1) Probability of Failure Evaluation

The damage level and failure probability evaluation unit 14 derives a stress response function Φ_{R} (ω) (response amplitude operator (RAO)) of an evaluation target part by a finite element analysis using the design information 194 such as the structural shape and dimensions of the evaluation target and design load conditions (a statistical value of a natural load such as a wave load, oil loading conditions in a FPSO or FSO, or the like) and the analysis model 197. The stress response function is a function such as an angular frequency ω.

In the stage of assembly and installation of an actual vessel, in particular, when a construction operation such as assembly or welding that deviates from a design is performed, or when a change in a structural feature assumed at the time of designing is confirmed through measurement after the assembly and the installation, there is a possibility that the stress response of an evaluation part is changed. In such a case, the damage level and failure probability evaluation unit 14 reflects, based on the assembly/installation/construction information 196, assembly/installation/construction information in the analysis model 197 and the service life evaluation model.

Examples of the monitoring information 198 include a position and an orientation of a ship acquired by a GPS, a GNSS, or the like, and wave information (a wave height, a wave direction, and a wave period) at a target position. The damage level and failure probability evaluation unit 14 uses the above information to calculate a wave spectrum S (ω) as a wave load acting on the marine structure (the marine vessel 1). A fatigue crack initiation life is defined as a state in which a fatigue damage level D exceeds 1. When fatigue evaluation is performed in a frequency domain, the fatigue damage level D accumulated over a certain evaluation period T can be evaluated by, for example, the following equation (1).

$$[ Math . 1 ]$$

$$D = \frac{{v}_{0} T}{\overline{a}} Γ ( 1 + \frac{m}{2} ) {( 2 \sqrt{2 {m}_{R 0}} )}^{m} \qquad ( 1 )$$

$$\overline{a} IS INDICATED AS \overline{a} IN THE DESCRIPTION .$$

Here, mR0 is a 0 order spectral moment of the stress response, and can be calculated by the following equation (2) using the stress response function Φ_{R} (ω) and the wave spectrum S (ω).

$$[ Math . 2 ]$$

$${m}_{R 0} = {\int }_{0}^{∞} {S}_{R} ( ω ) d ω = {\int }_{0}^{∞} {Φ}_{R}^{2} ( ω ) S ( ω ) d ω \qquad ( 2 )$$

V₀ is an average zero-crossing period. a⁻ and m are parameters related to fatigue strength, and are set from design information such as literature values or the test information 193 acquired by each company. The fatigue strength has an aleatory uncertainty and is generally represented by a fatigue strength parameter a⁻. By evaluating the uncertainty of the fatigue strength parameter a⁻ with a probability distribution such as a lognormal distribution and calculating a probability distribution of the fatigue damage level D, a failure probability can be formulated as “a probability p in which D is 1 or greater (D>1)”. Further, when the maintenance history information 199 such as inspection, reinforcement, and replacement history of a member is acquired in the actual vessel, the maintenance history information 199 is reflected in the evaluation of the fatigue damage level or the like. For example, even in a structural part whose service period is 15 years, when the evaluation part i is replaced in the twelfth year of service, a fatigue damage level is evaluated using only a load history after the time of replacement in the twelfth year of service. Damage level history data acquired through the inspection can also be used for correcting a fatigue evaluation model. When the evaluation period T is appropriately set, the fatigue damage level D in the future (future damage level) can be predicted by the equation (1).

### (1-2) Failure Consequence Evaluation

An consequence degree of a failure when a target part fails is normally evaluated through the FMEA 192 together with a frequency of the failure, a detectability of the failure, and the like. The failure consequence evaluation unit 15 calculates the consequence degree based on the FMEA 192. In this case, the consequence degree is evaluated by multifaceted key performance indices (KPIs) such as (A) safety (human influence), (B) environmental influence, (C) loss associated with production and operation stop of related equipment, and (D) failure damage amount. At this time, a maintenance cost and a down time of equipment are evaluated with reference to the data of the maintenance cost and period information 19A. For example, when an oil tank outer plate (an example of the part i) of an FPSO is adjacent to the external environment (the atmosphere, the ocean), the damage of the oil tank outer plate may lead to the outflow of oil to the ocean, and it is determined that the environmental influence is high.

### (1-3) Operation Measure Evaluation

When the marine vessel 1 is a moving vessel, the damage level and failure probability evaluation unit 14 can evaluate the accumulation of the fatigue damage level depending on a navigation route by combining a travel direction and a wave forecast included in the monitoring information 198, and present a navigation route for alleviating fatigue accumulation. This is determined in consideration of a trade-off including an increase or decrease in a navigation time and an increase or decrease in fuel consumption due to a navigation route change. In the case of a marine structure moored at a certain place such as an FPSO and an FSO, the stress response and the fatigue accumulation of each part depending on a load quantity (an example of the monitoring information 198) of each oil tank are predicted by the damage level and failure probability evaluation unit 14, whereby the operation method of the oil tanks can be studied and improved, and the fatigue accumulation at the evaluation part can be alleviated. The operation measure evaluation unit 16 selects a navigation route with the least fatigue damage level accumulation from among a plurality of navigation routes, and selects an operation method with the least fatigue accumulation from among a plurality of operation methods of the oil tanks.

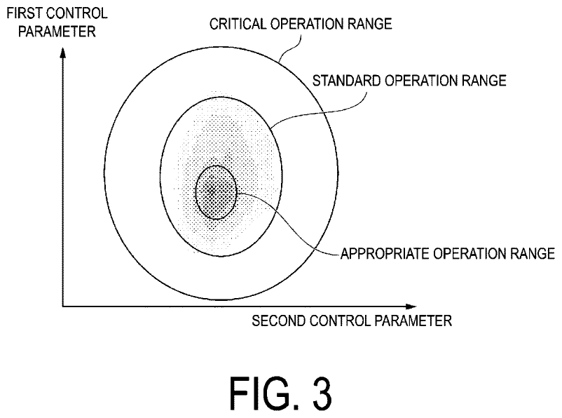

For example, the operation measure evaluation unit 16 calculates a travel direction (navigation route) and a speed of the marine vessel 1 at which the fatigue accumulation can be alleviated, or calculates an orientation and a position of the marine vessel 1 in accordance with the load quantity of the oil tanks, based on the relationship between the travel direction of the marine vessel 1 and the direction and strength of ocean waves. The display control unit 18 may display an operation measure calculated by the operation measure evaluation unit 16 as a diagram illustrated in FIG. 3. For example, the operation measure evaluation unit 16 calculates a critical operation range, a standard operation range, and an appropriate operation range for a travel direction and a speed at which a load received from ocean waves can be reduced. For example, the operation measure evaluation unit 16 calculates a travel direction such that the appropriate operation range is ±X° with reference to north, the standard operation range is ±X1° with reference to north (X1>X), and the critical operation range is ±X2° with reference to north (X2>X1). The operation measure evaluation unit 16 calculates a travel speed such that the appropriate operation range is ±Y1 (km/h) with reference to Y, the standard operation range is ±Y2 (km/h) with reference to Y (Y2>Y1), and the critical operation range is ±Y3 (km/h) with reference to Y (Y3>Y2). The display control unit 18 may receive two control parameters of the travel direction and the travel speed from the operation measure evaluation unit 16, and may output a two-dimensional graph using the selected two control parameters as axes in which the magnitude of a profit (in this case, the profit is that the damage which the marine vessel 1 receives from ocean waves is small) is displayed as a heat map and frame lines represent the critical operation range, the standard operation range, and the appropriate operation range, as illustrated in FIG. 3.

### (1-4) Maintenance Measure Evaluation

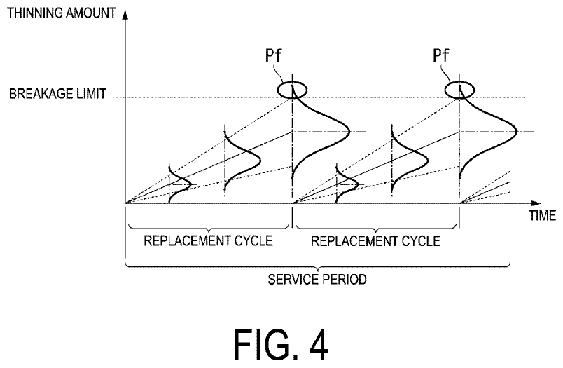

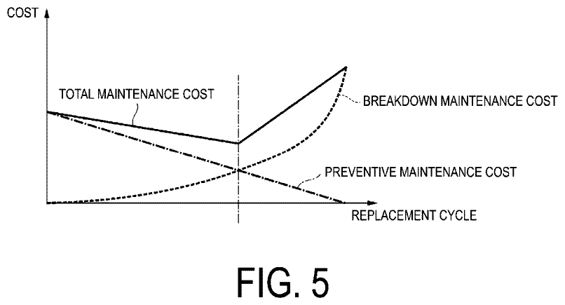

Although alleviation and recovery of the fatigue damage level accumulation can be expected through a reinforcement work or a replacement work of on a target part, costs are incurred to perform these measure works. In risk-based engineering, an appropriate measure work is examined for a risk defined by a product of a failure probability and a consequence degree of a failure taking into account equipment recovery measure costs (a work cost, a spare cost, a material cost, and the like evaluated with reference to the maintenance cost and period information 19A) with consideration of a trade-off between the both. An example of the examination method is illustrated in FIG. 4 and FIG. 5. The graph in FIG. 4 shows a result of a simulation of thinning amount in which uncertainties in the worst case to the best case assumed for degrees of progression of deterioration (thinning amount) caused at the target part i are set as a probability distribution. In the example of FIG. 4, replacement is performed twice at predetermined intervals during a service period. In each replacement cycle, a probability Pf that the thinning amount of the target part exceeds a breakage limit represents a failure probability of the target part. For example, the maintenance measure evaluation unit 17 calculates a failure probability and the number of times of maintenance per replacement cycle according to the replacement cycle for the target part i, and obtains an expected value of the number of times of breakage during the service period from the product of the failure probability and the number of times of maintenance. FIG. 5 illustrates an example of the relationship between a preventive maintenance cost, a breakdown maintenance cost, and a total maintenance cost according to the replacement cycle. The maintenance measure evaluation unit 17 obtains a preventive maintenance cost of the target part and an expected value of a breakdown maintenance cost calculated from the expected value of the number of times of breakage of the target part. The preventive maintenance cost is a cost required for replacement of the target part. The breakdown maintenance cost is calculated as an expected value by multiplying a unit cost required for actual breakdown maintenance (the maintenance cost and period information 19A) by the expected value of the number of times of breakage. The graph of FIG. 5 shows an example of the relationship between the length of the replacement cycle of the target part i and each of the preventive maintenance cost, the breakdown maintenance cost, and the total maintenance cost, which is the sum of the preventive maintenance cost and the breakdown maintenance cost, of the target part. The longer the replacement cycle, the lower the preventive maintenance cost. On the other hand, the longer the replacement cycle of the target part i, the higher the breakdown maintenance cost. For example, the maintenance measure evaluation unit 17 sets, as an optimum replacement cycle, a replacement cycle at which the total maintenance cost, which is the sum of the preventive maintenance cost and the breakdown maintenance cost, is the lowest.

### (2) Corrosion Evaluation at Any Structural Part

### (2-1) Probability of Failure Evaluation

The corrosive damage state of a target part is estimated from statistical information of a literature, the failure statistical information 191 in the past, and the design information 194 such as a corrosion prediction formula according to a use environment (temperature, humidity, or the like). For example, a model of occurrence and progress of a corrosive damage is divided into two stages: (a) a corrosion occurrence time model for predicting an occurrence time of corrosion and (b) a corrosion amount prediction model in which corrosion thinning progresses after the occurrence of the corrosion. Since a corrosive damage is a phenomenon with large variations, probability and statistical methods are generally used. When past actual statistical information is used, a corrosive damage occurrence time T_{C} can be directly estimated from a probability distribution such as a lognormal distribution shown below.

$$[ Math . 3 ]$$

$${T}_{c} ( {μ}_{{T}_{c}} , {σ}_{{T}_{c}} ) = \frac{1}{\sqrt{2 π} {σ}_{{T}_{c}}} exp [ - \frac{{\{ t - {μ}_{{T}_{c}} \}}^{2}}{2 {σ}_{{T}_{c}}^{2}} ] \qquad ( 3 )$$

A time-series corrosion amount d(t) is estimated from, for example, the following exponential law (equation (4)).

$$d ( t ) = a {( t - {T}_{C} )}^{b} \qquad ( 4 )$$

Here, a logarithmic mean T_{C} and a logarithmic standard deviation σ_{TC} related to a corrosion occurrence time and an exponential law parameters a and b related to a corrosion amount are estimated from, for example, past actual damage data and statistical data (the design information 194). At this time, if an anti-corrosion treatment has been applied to the actual vessel to be evaluated, the assembly/installation/construction information 196 related thereto is reflected in the corrosion prediction model. Examples of the monitoring information 198 include the monitoring information 198 obtained by a thickness measurement sensor using ultrasonic waves, which can be used for soundness evaluation including measurement errors. In a case where explanatory variables such as temperature and humidity are used for prediction of corrosive damage and the monitoring information 198 thereof is available, the damage level and failure probability evaluation unit 14 reflects these in the corrosion prediction model. Further, when the maintenance history information 199 such as inspection, reinforcement, and replacement history of a member is acquired in the actual vessel, the damage level and failure probability evaluation unit 14 reflect the maintenance history information 199 in the corrosion evaluation. For example, even in a structural body whose service period is 15 years, when the evaluation part is replaced in the twelfth year of service, the corrosion evaluation is performed for after the time of replacement in the twelfth year of service. Damage level history data acquired through the inspection can also be used for correcting a damage progress speed model. The corrosion amount d(t) is an example of the damage level. The corrosion amount d(t) in the future (future damage level) can be predicted by the equation (4).

### (2-2) Failure Consequence Evaluation

The failure consequence evaluation is the same as in the case of the fatigue crack initiation (1-2).

(2-3) Operation Measure Evaluation Not applicable.

### (2-4) Maintenance Measure Evaluation

The maintenance measure evaluation is the same as in the case of the fatigue crack initiation (1-4). However, an anti-corrosion treatment is performed instead of the reinforcement work.

### (3) Failure of Device on Marine Structure

In general, various mechanical equipment is mounted on a marine structure. In the case of a floating offshore windmill, a generator, a speed increaser, and the like are mounted. In the case of an FPSO, a pump, a valve, a generator, a gas turbine, a gas-liquid separator, and the like are mounted. In this section, a device mounted on a structure will be exemplified.

### (3-1) Failure Probability Evaluation

Device failures include, in addition to clear breakage events such as crack initiation, malfunctions such as malfunction of a valve and performance deterioration of a pump. Prediction of a device failure includes (a) failure prediction using an aging deterioration model mainly based on design information for evaluation of fatigue crack initiation and corrosion, and (b) failure prediction mainly using a random failure model by use of failure statistical information of the device. For (a), as described above, the evaluation is performed using various information such as various design information and manufacturing information. For (b), the failure statistical information 191 includes an in-house database accumulated by an analyst in an organization of the analyst and an open failure rate database (Offshore and Onshore Reliability Database (OREDA) or the like), and these databases are analyzed to extract a statistical failure rate λ of the target device. For matching between a device described in the open failure rate database and the evaluation target device, the design information and the manufacturing information 195 of the device, or the like are referred to and information having a high similarity is selected and used. The statistical failure rate λ is a probability parameter of an exponential distribution f(t;λ)=λexp[−λt] which is a probability model of an occurrence time interval of a random failure.

### (3-2) Failure Consequence Evaluation

The failure consequence evaluation is the same as in the case of the fatigue crack initiation (1-2).

(3-3) Operation Measure Evaluation Not applicable.

### (3-4) Maintenance Measure Evaluation

Since it is difficult to predict an occurrence time of a random failure, maintenance measures mainly include early recovery of the failure by holding a spare part. A probability mass of an occurrence frequency x of a random failure during the certain evaluation period T can be evaluated using a Poisson distribution P (x|m=λT) of the following equation (5).

$$[ Math . 4 ]$$

$$P ( x \vert m = λ T ) = \frac{{m}^{x} exp ( - m )}{x !} \qquad ( 5 )$$

From the above-described probability mass function P (x|m=λT) and the evaluation of a consequence degree per failure, it is possible to probabilistically calculate a gain of avoiding the prolongation of failure stop according to the number of spare parts held. By adding to the gain a spare cost (spare parts holding cost, warehouse cost, tax, and the like) according to the number of spare parts held, it is possible to calculate an optimum number of spare parts held by which a value obtained by subtracting the cost from the gain is maximized. The spare cost and the failure consequence evaluation are set with reference to the maintenance cost and period information and the FMEA.

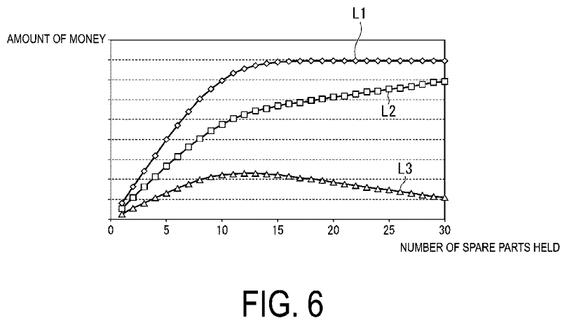

As a failure consequence, for example, an economic loss (loss of an opportunity of production or power generation, a labor cost, an replacement machine and fuel cost, or the like) due to production stop of an FPSO or power generation stop of an offshore windmill occurs as a specific example of (C) loss associated with production and operation stop of related equipment. For example, the maintenance measure evaluation unit 17 combines the prediction of the number of failures during the evaluation period T, the failure consequence evaluation, and the spare cost evaluation, thereby calculating the number of spare parts held by which the sum of values obtained by subtracting the cost from the gain is minimized. The graph of FIG. 6 shows the relationship between the effect of avoiding the prolongation of failure stop and the spare cost according to the number of spare parts held. In FIG. 6, the vertical axis represents the amount of money, and the horizontal axis represents the number of spare parts held. A graph L1 shows the effect of avoiding the prolongation of failure stop by holding spare parts, a graph L2 shows the spare cost, and a graph L3 shows the effect of preventing the prolongation of failure stop with respect to the spare cost. The maintenance measure evaluation unit 17 calculates functions of L1 to L3 in FIG. 6 by using the number of spare parts held as an evaluation index. In the example of FIG. 6, when the number of spare parts held is 12, the effect of preventing the prolongation of failure stop with respect to the spare cost is maximized, and thus the maintenance measure evaluation unit 17 sets the optimum number of spare parts held to “12”. For the holding of spare parts, the spare cost can be reduced by optimizing the situation including a plurality of systems having common spare parts, instead of managing a single system.

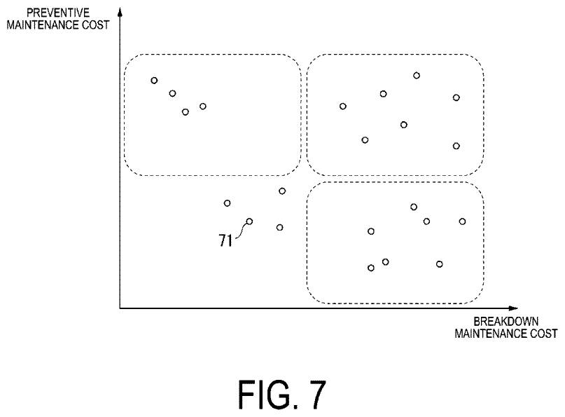

Also for devices, it is possible to calculate a repair or replacement timing that can optimize the preventive maintenance cost and the breakdown maintenance cost for each of the devices from the failure probability of the devices and the maintenance costs before and after breakdown in the same manner as described with reference to FIG. 5. For example, in the case where maintenance is performed for all components and all devices of the marine vessel 1 on a certain cycle, the maintenance measure evaluation unit 17 calculates the total of preventive maintenance costs and the total of breakdown maintenance costs required for the maintenance of all the components and all the devices. This is considered as one maintenance menu item. The maintenance measure evaluation unit 17 calculates the total of preventive maintenance costs and the total of breakdown maintenance costs for maintenance menu items with variously-changed maintenance cycles. FIG. 7 shows preventive maintenance costs and breakdown maintenance costs for various maintenance menu items. The display control unit 18 may output the graph illustrated in FIG. 7 in which the total of preventive maintenance costs and the total of breakdown maintenance costs for each of the maintenance menu items calculated by the maintenance measure evaluation unit 17 are plotted. Referring to the graph of FIG. 7, a user can select a maintenance menu item 71 that can reduce both the preventive maintenance cost and the breakdown maintenance cost.

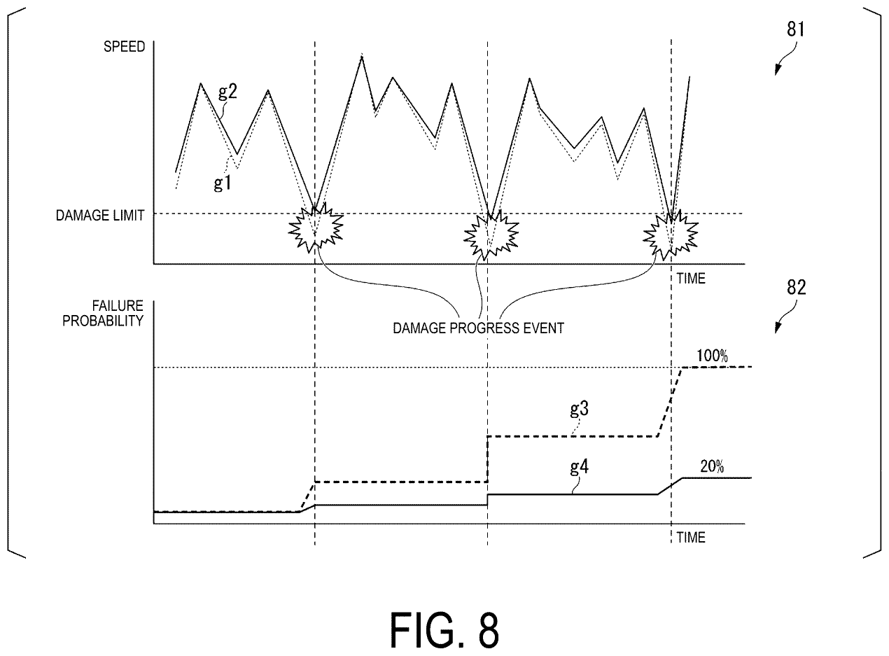

For example, the operation measure evaluation unit 16 may calculate economic efficiency comparison information based on the simulation results of the travel speed of the marine vessel 1 according to the initial condition and the optimized travel speed. For example, the damage level and failure probability evaluation unit 14 calculates a failure probability of a certain device on the marine vessel 1 based on, for example, a predetermined travel speed and wave prediction. The predetermined travel speed is indicated by a speed curve g1 in a graph 81 in the upper part of FIG. 8, and the transition of the failure probability at that time is indicated by a failure probability curve g3 in a graph 82 in the lower part of FIG. 8. The damage level and failure probability evaluation unit 14 calculates a failure probability of the relevant part when the marine vessel 1 navigates at a speed that is calculated by the operation measure evaluation unit 16 and at which the influence of ocean waves can be reduced. The travel speed with the adoption of an operation method calculated by the operation measure evaluation unit 16 is indicated by a speed curve g2 in the graph 81, and the transition of the calculated failure probability is indicated by a failure probability curve g4 in the graph 82. The display control unit 18 may generate and display the graph illustrated in FIG. 8. The operation measure evaluation unit 16 may subtract a value, which is obtained by multiplying a maintenance cost or a damage amount in the case of traveling at the speed indicated by g2 by a failure probability of 20%, from a value, which is obtained by multiplying a maintenance cost or a damage amount in the case of traveling at the speed indicated by g1 by a failure probability of 100% to obtain a potential lost profit in the case where the operation method calculated by the operation measure evaluation unit 16 is adopted, and display this value on the display device 2 together with the graph of FIG. 8.

As described above with some examples taken, the control unit 13 (the damage level and failure probability evaluation unit 14, the failure consequence evaluation unit 15, the operation measure evaluation unit 16, and the maintenance measure evaluation unit 17) calculates failure probabilities, damage levels, consequence degrees, risks (=failure probability×consequence degree), operation measures, maintenance measures, and the like of the part i and the failure mode j at present and in the future by a known calculation method depending on each part (step S4).

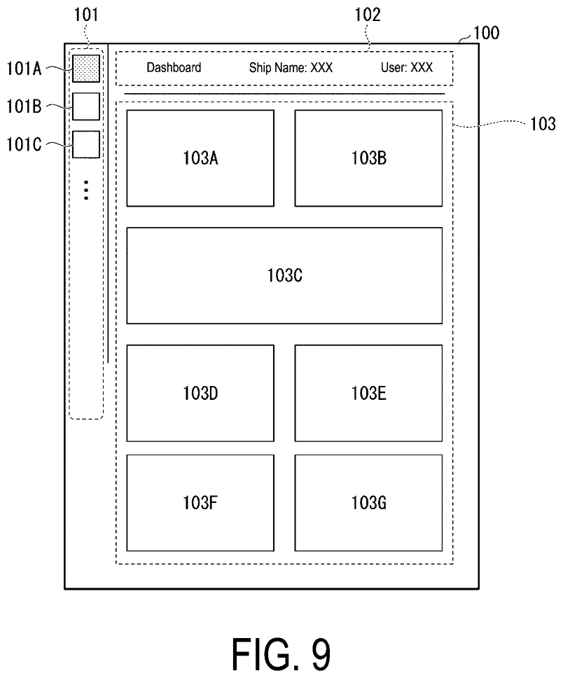

Next, the control unit 13 (the display control unit 18) visualizes the information calculated as above (step S4). For example, the display control unit 18 generates monitoring screens illustrated in FIG. 9 to FIG. 12 and outputs the monitoring screens to the display device 2. The monitoring screens include an insight screen 100, a risk analysis screen 200, and a sensor information screen 300. These screens can be switched and displayed by selecting them in a menu region 101 illustrated in FIG. 9 and the like.

### Types of Monitoring Screens

FIG. 9 illustrates a layout example of the insight screen 100. The insight screen 100 is a screen that serves as a kind of dashboard, and is a screen that collectively displays the entire image of damages or risks accumulated in the marine vessel 1, information with high urgency, information updated daily, information obtained by processing sensor information, and information a user is interested in. The insight screen 100 includes the menu region 101, a header region 102, and an information display region 103. Buttons 101A to 101C are arranged in the menu region 101. When the button 101A is selected, the display control unit 18 displays the insight screen 100, when the button 101B is selected, the display control unit 18 displays the risk analysis screen 200, and when the button 101C is selected, the display control unit 18 displays the sensor information screen 300. In the header region 102, a name of the screen (for example, Dashboard), identification information of the marine vessel 1, a user ID, and the like are displayed. In the information display region 103, various information related to the damage state and the risks of the marine vessel 1 are displayed. The information display region 103 is divided into, for example, regions 103A to 103G, and different information is displayed in each region. An example of a display content will be described below. The arrangement of the regions 103A to 103G illustrated in FIG. 9 is merely an example. For example, the region 103A and the region 103B may be arranged adjacent to each other in the vertical direction.

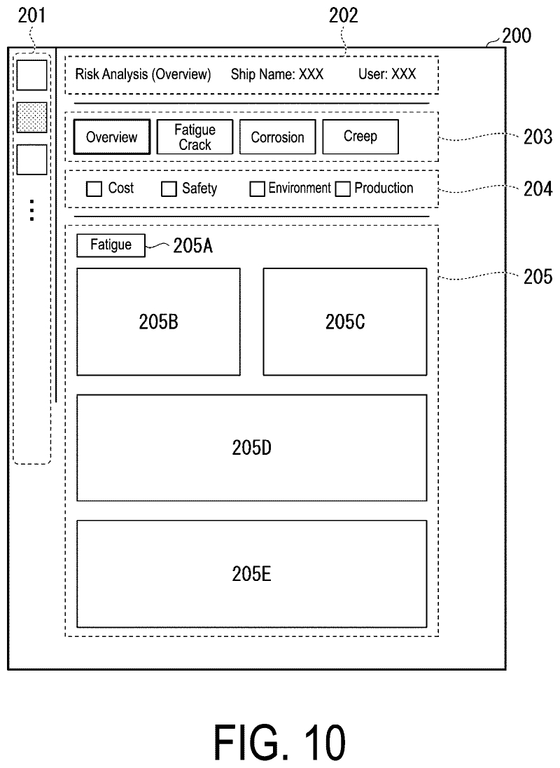

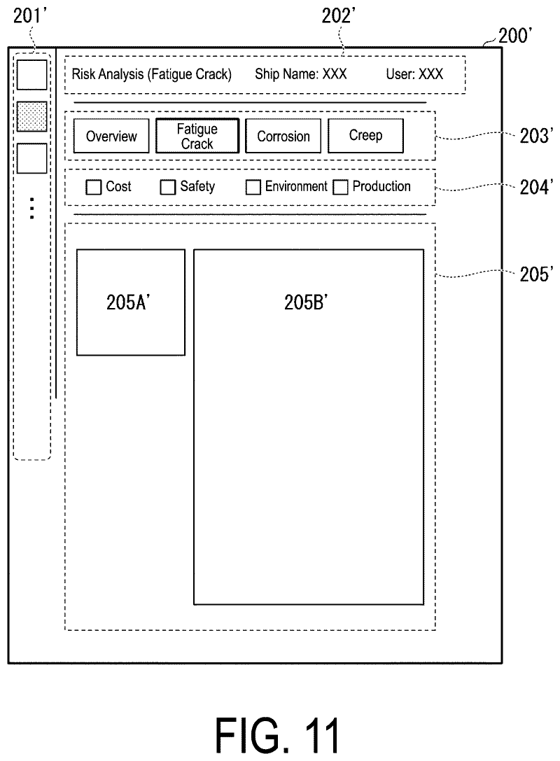

FIG. 10 illustrates a layout example of the risk analysis screen 200 (an overview screen 200). The risk analysis screen 200 is a screen that displays the overall tendency of damages and risks accumulated in the marine vessel 1 in more detail. In the risk analysis screen 200, the overview screen 200 (FIG. 10) for displaying the overall situation of risks and the like and an individual screen 200′ (FIG. 11) for displaying the detailed contents for each individual failure mode can be switched and displayed. The overview screen 200 includes a menu region 201, a header region 202, a switching tab region 203, a key performance indices (KPI) setting region 204, and an information display region 205. The menu region 201 is the same as in the case of the insight screen 100. In the header region 202, a name of the screen (for example, Risk analysis (Overview)), identification information of the marine vessel 1, a user ID, and the like are displayed. In the switching tab region 203, “Overview”, “Fatigue crack”, “Corrosion”, “Creep”, and the like are displayed. When “Overview” is selected, the overview screen 200 illustrated in FIG. 10 is displayed. When “Fatigue crack” or “Corrosion” is selected, an individual screen 200′ displaying information on “Fatigue crack” and an individual screen 200′ displaying information on “Corrosion” are displayed, respectively. In the KPI setting region 204, one or more of “Cost”, “Safety”, “Environment”, and “Production” can be selected. These items are related to the consequence degree at the time of failure, and when “Cost” is selected, the magnitude of the cost required at the time of failure becomes an index. When “Safety” is selected, the magnitude of the influence in terms of safety becomes an index, and when “Environment” is selected, the magnitude of the influence on the environment becomes an index. “Production” refers to, for example, oil that is a product in the case where the marine vessel 1 is an FPSO, and the magnitude of the lost profit related to the amount of oil that cannot be produced at the time of failure or the inability to produce oil becomes an index. When a plurality of indices are selected in the KPI setting region 204, the total of the selected indices becomes an index. The set content of the KPI setting region 204 is carried over even when another item is selected in the switching tab region 203 and the individual screen 200′ is displayed. The information display region 205 is divided into, for example, regions 205B to 205E, and different information is displayed in each region. An example of display content will be described below. The arrangement of the regions 205B to 205E illustrated in FIG. 10 is merely an example. For example, the region 205B and the region 205C may be arranged adjacent to each other in the vertical direction. The regions 205D and 205E may have the same size as the region 205B. A switching list 205A is arranged in the information display region 205. The switching list 205A is valid in the entirety of the overview screen 200, and individual failure modes such as fatigue crack, corrosion, creep, and the like can be selected in the switching list 205A. When the fatigue crack is selected in the switching list 205A, the risk for the failure probability due to the “Fatigue crack” is displayed on the overview screen 200. Unlike the KPI setting region 204, the content selected in the switching list 205A is not carried over to another screen (the individual screen 200′).

FIG. 11 illustrates a layout example of a risk analysis screen 200′ (an individual screen 200′). The individual screen 200′ is a screen that displays detailed contents of a failure probability, a damage level, and a risk for each failure mode. The individual screen 200′ includes a menu region 201′, a header region 202′, a switching tab region 203′, a KPI setting region 204′, and an information display region 205′. The menu region 201′ is the same as in the case of the insight screen 100. In the header region 202′, a name of the screen (for example, Risk analysis (Fatigue crack)), identification information of the marine vessel 1, a user ID, and the like are displayed. In the switching tab region 203′, overview, fatigue crack, corrosion, creep, and the like are displayed, and when “Fatigue crack” is selected, the individual screen 200′ for fatigue crack illustrated in FIG. 11 is displayed. The KPI setting region 204′ is the same as the KPI setting region 204 of the overview screen 200. The information display region 205′ is divided into, for example, regions 205A′ to 205B′, and different information is displayed in each region. An example of a display content will be described below.

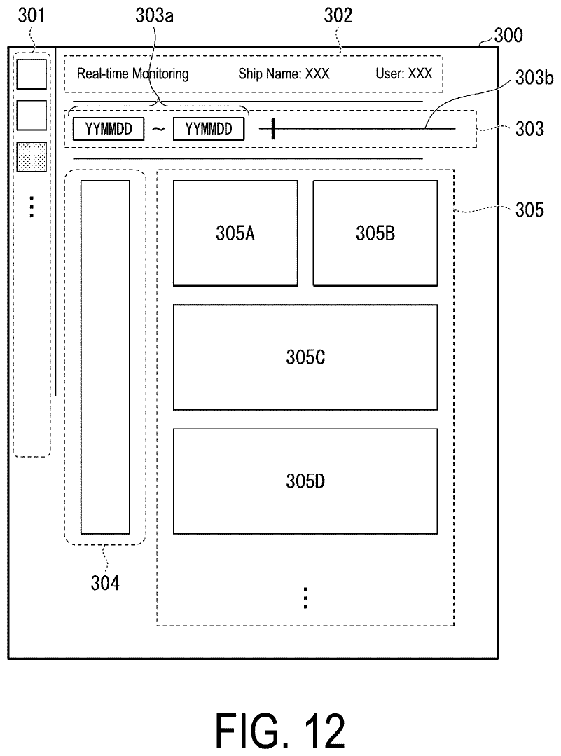

FIG. 12 illustrates a layout example of the sensor information screen 300. The sensor information screen 300 includes a menu region 301, a header region 302, a period designation region 303, a display item selection region 304, and an information display region 305. The menu region 301 is the same as in the case of the insight screen 100. In the header region 302, a name of the screen (for example, Real-time monitoring), identification information of the marine vessel 1, a user ID, and the like are displayed. The period designation region 303 includes a setting field 303a for a target period of monitoring information (sensor information) and a scroll bar 303b. For example, when 2022 Jan. 1 to 2022 Jan. 31 is input in the setting field 303a, the sensor information measured during this period becomes the display target. By setting in this way, the left end of the scroll bar 303b is set to 2022 Jan. 1, and the right end is set to 2022 Jan. 31. Moving the scroll bar 303b to the left and right allows the sensor information at any date and time from 2022 Jan. 1 to 2022 Jan. 31 to be displayed in the information display region 305. The display item selection region 304 is a region for selecting information measured by which sensor to be displayed or a value calculated based on information measured by which sensor to be displayed. For example, one or more of a travel direction, an output, a temperature, a rotational speed, location information, wave information, strain information, an acceleration, a thickness, a moment, a fatigue damage level, a crack length, a corrosion thinning amount, and the like can be selected. Although the items are selected from the display item selection region 304 in FIG. 12, the items such as the travel direction and the output may be arranged in a tab format so that the monitoring information to be displayed can be selected from the tabs. The information display region 305 is divided into, for example, regions 305A to 305D, and different monitoring information is displayed in each region. An example of a display content will be described below.

### Specific Example of Monitoring Screen

Next, specific monitoring screens will be described.

### Insight Screen

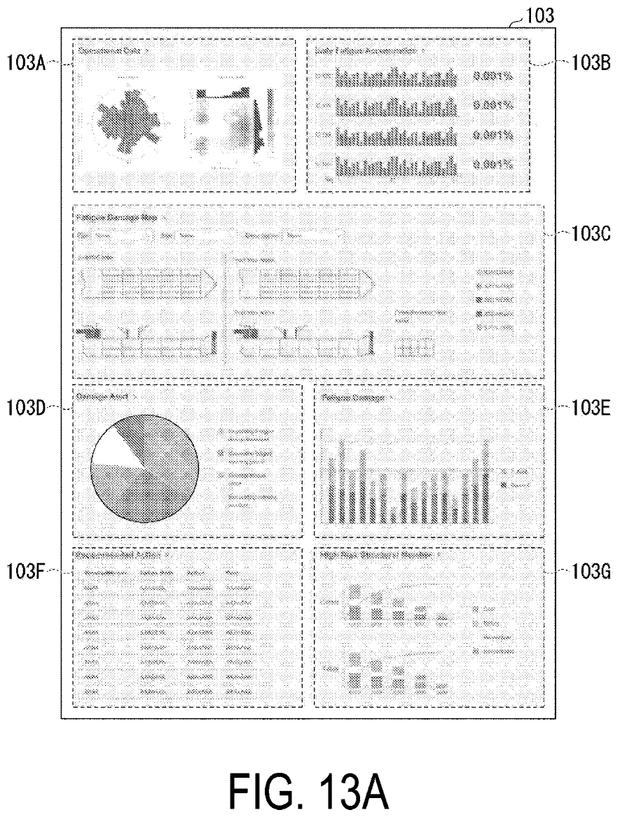

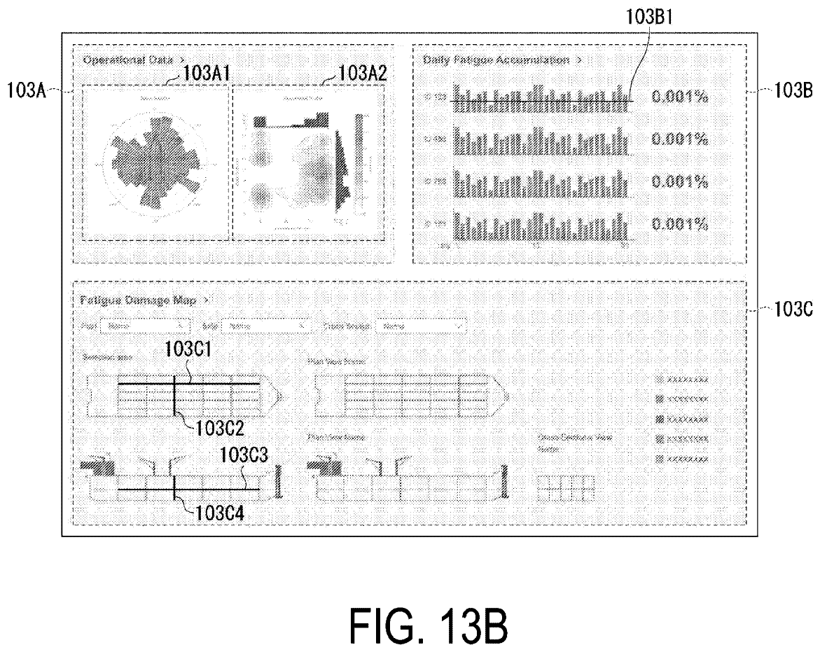

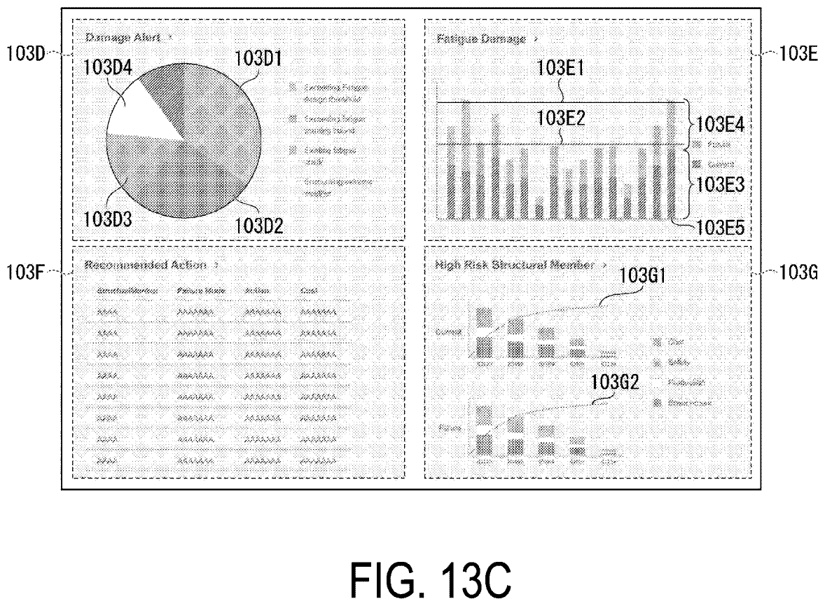

FIGS. 13A to 13C are the first to third diagrams each illustrating an example of the insight screen according to the embodiment. FIG. 13A illustrates an example of the information display region 103 of the insight screen 100. FIG. 13B and FIG. 13C illustrates enlarged views. A diagram illustrating a distribution of wave directions during a predetermined period is displayed in a left region 103A1 of a region 103A in FIG. 13B, and a diagram illustrating a distribution of wave heights and wave frequencies during the predetermined period is displayed in a right region 103A2. The display control unit 18 displays the region 103A based on the wave information of the monitoring information 198. In the region 103B, a daily damage level accumulated by a load received from waves is displayed for each part. In the region 103B, a graph for each of five parts is displayed, and the vertical axis of each graph represents damage level and the horizontal axis represents time (day). Each line in each graph indicates a daily damage level, and the transition of the daily damage levels for the last one month is displayed in FIG. 13B. The damage level and failure probability evaluation unit 14 calculates daily damage levels for the five parts, and the display control unit 18 displays the region 103B based on the calculation result. The daily damage level is displayed in the region 103B of FIG. 13B as an example, but the damage level may be displayed for each predetermined period such as every hour or every half day may be displayed. A threshold value 103B1 represents a threshold value of the damage level, and a user can look back whether daily operation was appropriate while comparing the threshold value with the daily damage level. For the display of the regions 103A and 103B, for example, the display control unit 18 may display a view of an Integrity Operating Window (IOW) illustrated in FIG. 3 on the insight screen 100. This can grasp what kind of operation should be performed based on a future wave prediction to reduce the accumulation of damages to each part while grasping past wave information and the damage level of each part due to past operation.

In a region 103C of FIG. 13B, parts at which fatigue crack damages are accumulated are displayed so as to be superimposed on a structure diagram of the ship (damage map). Parts 103C1 to 103C4 are parts at which the damage level or the failure probability is equal to or greater than the threshold value. In the example of the drawing, a damaged portion related to a fatigue crack is displayed, but a drawing displaying a damaged portion due to corrosion or a crack or a portion having a high possibility of a device failure may be displayed. The ship structure and the damaged portion may be displayed in 3D.

In a region 103D of FIG. 13C, the number of parts at which the damage level due to fatigue or the like exceeds a limit threshold value (103D1), the number of parts at which the damage level exceeds a warning threshold value (103D2), the number of parts at which a cleavage or a crack has occurred (103D3), and the number of parts at which a large load such as severe weather has occurred (103D4) are indicated in a circular graph. In a region 103E, current and future (a predetermined time ahead, for example, at the time of the next maintenance and inspection) damage levels of each part are indicated in a bar graph. A threshold value 103E1 represents the limit threshold value, a threshold value 103E2 represents the warning threshold value, 103E3 represents the current damage level of a part, and 103E4 represents an increase in the damage level of the part in the future. That is, 103E3+103E4 represents the future damage level of the parts. In the case of a part 103E5, the expected future damage level exceeds the limit threshold value. In such a case, an operation measure or a maintenance measure is needed at least before the limit threshold value is exceeded.

In a region 103F of FIG. 13C, measure options are displayed. For example, in the region 103F, a target part, a failure mode, a measure option (an effective operation measure or an effective maintenance measure), and a cost required for the measure are displayed. For the display of this content, for example, the operation measure evaluation unit 16 and the maintenance measure evaluation unit 17 select a member having a large damage level with respect to a part having a high damage level or a high risk displayed in the regions 103D, 103E, and 103G, and calculate an operation method for reducing a load on the member and calculate an optimum (for example, low-cost, or early executable) maintenance menu item, respectively, and the display control unit 18 displays the calculated measures in the region 103F. However, in general, an automatic evaluation system has a problem at the initial stage of operation. The automatic evaluation system may propose a measure that is not convenient for a user. Thus, an approval authority is given to a user who has knowledge about the damage of each part, and after an analytical result of a failure probability, a risk (for example, 103E and 103G), or the like, or an operation or maintenance measure (for example, 103F) calculated by the operation measure evaluation unit 16 or the maintenance measure evaluation unit 17 is approved by the user, the analytical result or the operation or maintenance measure is displayed to another user. This can prevent an erroneous analytical result or an operation or maintenance measure from being displayed by automatic processing.

A Pareto chart is displayed in the region 103G. The upper graph is a graph indicating risks from each viewpoint of cost, safety, environment, and production for each part at present. The lower graph is a graph indicating the risks of the same contents in the future. In the upper and lower graphs, the vertical axis represents the magnitude of the risks, and the horizontal axis represents the parts. As illustrated in the drawing, since the breakdown of respective risks of cost, safety, environment, and production is displayed, it is possible to know a reason why the risk of a certain component is high, that is, it is possible to know that the risk is high as a whole because the risks from which viewpoint is high. By comparison with the measure displayed in the region 103F, it is possible to know why the measure is necessary. Curves 103G1 and 103G2 each represent the sum of risk values of each part, and the sum of all the risk values of the five parts is 100%.

### Risk Analysis Screen (Overview Screen)

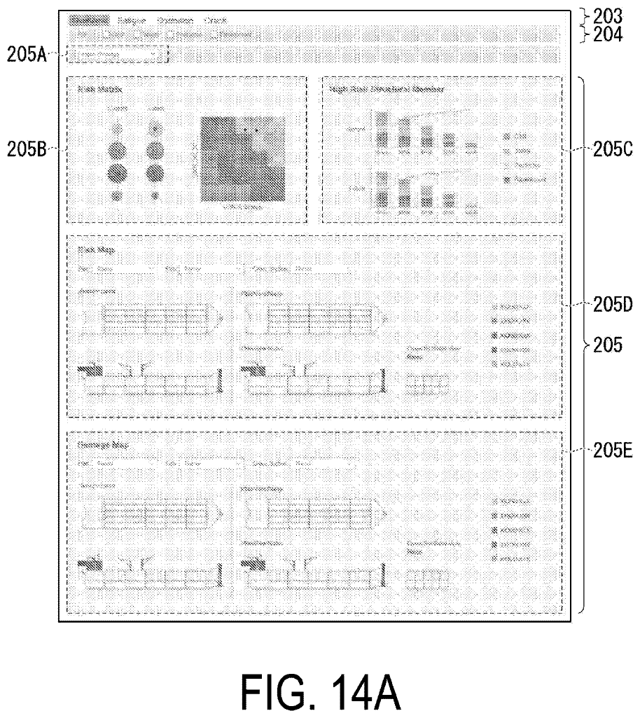

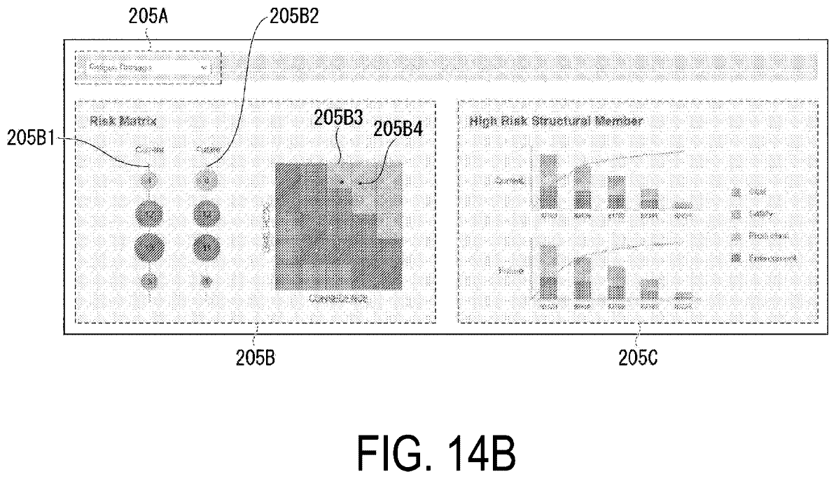

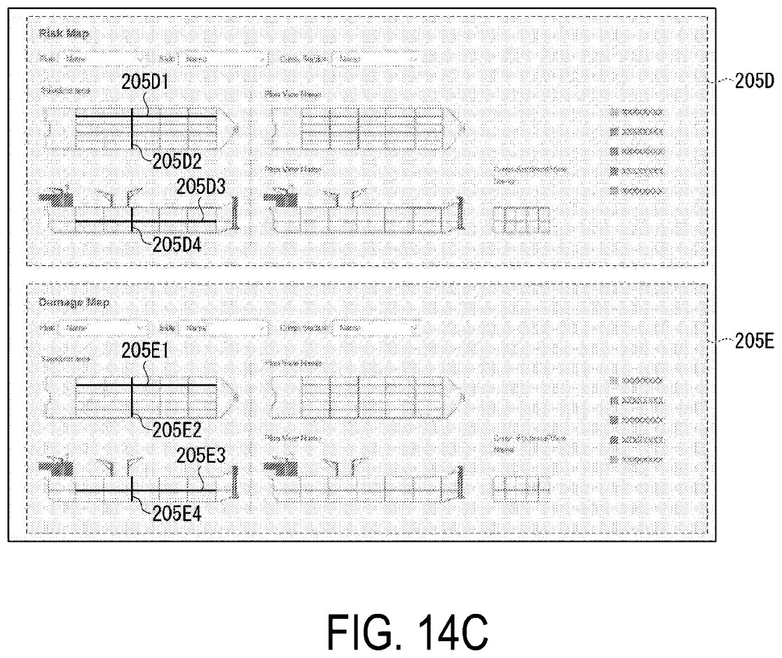

FIGS. 14A to 14C are the first to third diagrams each illustrating an example of the risk analysis screen (overview) according to the embodiment. FIG. 14A illustrates an example of the switching tab region 203, the KPI setting region 204, and the information display region 205 of the overview screen 200. Since “Overview” (corresponding to “Overview” in FIG. 10) is selected in the switching tab region 203, the overview screen 200 is displayed. In the information display region 205, a risk is calculated using an index selected in the KPI setting region 204. Since the setting of the KPI setting region 204 is common to the individual screen 200′, by switching the display content using the switching tab region 203 without changing the setting of the KPI setting region 204, it is possible to switch between the overview screen 200 and the individual screen 200′ while performing risk evaluation based on the same index.

FIG. 14B and FIG. 14C illustrate enlarged views of the information display region 205. “Fatigue Damage” is selected in a region 205A. This means that the failure probability in the overview screen 200 is a failure probability due to a fatigue crack. A risk matrix 205B3 is displayed in the region 205B. The vertical axis of the risk matrix 205B3 represents the occurrence probability of failure (LIKELIHOOD), and the horizontal axis represents the consequence degree at the time of failure (SUBSEQUENCE). The occurrence probability becomes higher upward in the vertical axis, and the consequence degree becomes larger rightward. In this drawing, the occurrence probability represents the probability of occurrence of a fatigue crack based on the selection in the region 205A. The consequence degree is the sum of the consequence degrees of the indices selected in the KPI setting region 204. For example, when the influences on cost and environment are selected in the KPI setting region 204, the sum of a consequence degree from the viewpoint of cost and the magnitude of an influence on the environment at the time of failure becomes the index of the horizontal axis. The risk matrix 205B3 is color-coded as follows. Areas at the lower left where the occurrence probability and the consequence degree are small are colored green. Areas where the occurrence probability and the consequence degree are relatively small, areas where the occurrence probability is high and the consequence degree is small, and areas where the consequence degree is large and the occurrence probability is low are colored yellow. Areas where the occurrence probability and the consequence degree are medium, areas where the occurrence probability is high and the consequence degree is relatively small, and areas where the consequence degree is large and the occurrence probability is relatively low are colored orange. Areas at the upper right where the occurrence probability and the consequence degree are high are colored red. When there is a part having an occurrence probability and a consequence degree corresponding to each area, the part is displayed by a dot (for example, a dot 205B4) in the corresponding area of the risk matrix 205B3. For example, when a mouse pointer is placed on the dot, the details of the part, the occurrence probability, and the consequence degree indicated by the dot are displayed. In skewer-shaped displays 205B1 and 205B2, the numbers of parts included in the green areas, the yellow areas, the orange areas, and the red areas are displayed in this order from the bottom. The current numbers of parts are displayed in 205B1, and the future numbers of parts are displayed in 205B2. Thus, a user can grasp the number of parts of the marine vessel 1 that are in a dangerous state and the number of parts that are in a safe state.

In the region 205C, a diagram similar to the Pareto chart of the region 103 described with reference to FIG. 13C is displayed. Note that, depending on the selection in the KPI setting region 204, it is possible to display Pareto charts with changed indices such as a Pareto chart focused on four indices of cost, safety, environment, and production, a Pareto chart focused on cost only, and a Pareto chart focused on cost and safety.

In the region 205D of FIG. 14C, parts at which risks are accumulated are displayed so as to be superimposed on a structure diagram of the ship (risk map). Parts 205D1 to 205D4 are parts at which the risk is equal to or greater than a threshold value. The risk described here is a value calculated by the product of the consequence degree based on the setting of the KPI setting region 204 and the occurrence probability of the failure mode selected in the region 205A. For example, when four indices of cost, safety, environment, and production are selected, the display control unit 18 calculates a risk by multiplying the consequence degrees of these four indices by the occurrence probability of a fatigue crack, and highlights a part whose value of the risk is equal to or greater than a predetermined threshold value. The ship structure and the parts with a high risk may be displayed in a three-dimensional model.

In a region 205E of FIG. 14C, the damage map illustrated in the region 103C of FIG. 13B is displayed. Parts 205E1 to 205E4 are parts at which the damage level or the failure probability is equal to or greater than a threshold value. In the example of the drawing, depending on the selection in the region 205A, the parts at which the damage level or the failure probability related to a fatigue crack is equal to or greater than the threshold value are displayed. By displaying the risk map of the region 205D and the damage map of the region 205E side by side, it is possible to individually grasp portions at which damages are accumulated and portions at which risks are high (for example, a risk value becomes high when the consequence degree is high even if the failure probability is low).

### Risk Analysis Screen (Individual Screen)

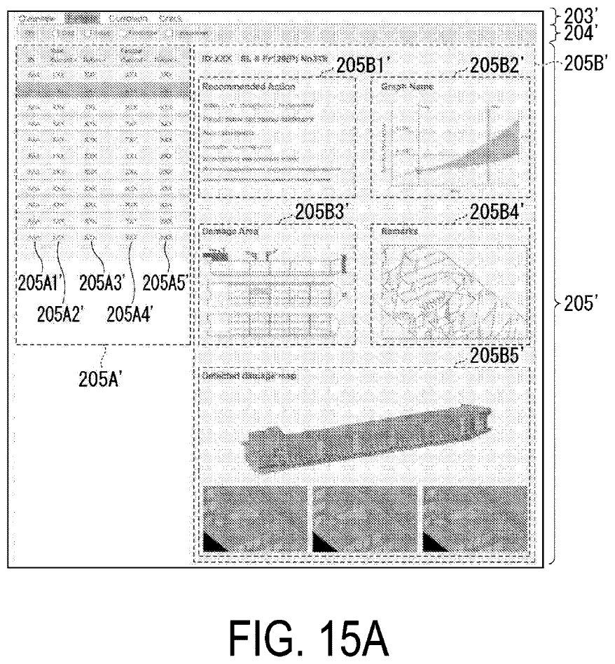

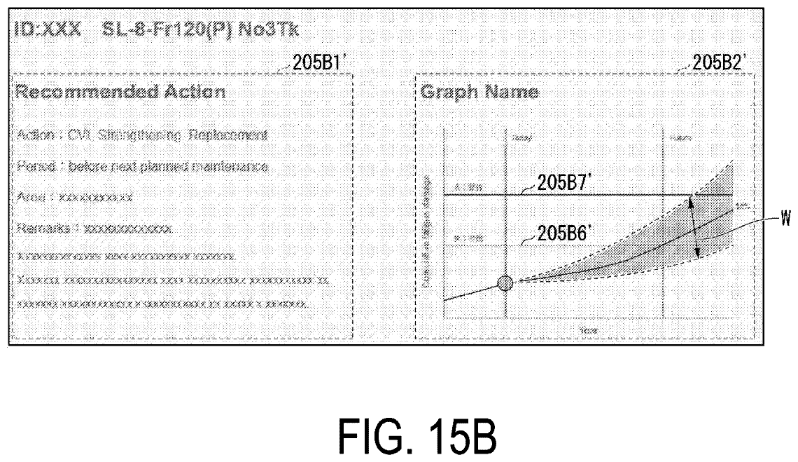

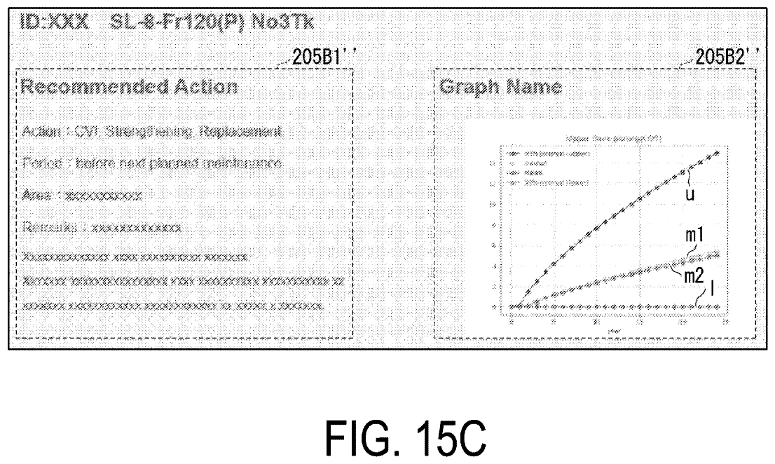

FIGS. 15A and 15B are the first and second diagrams each illustrating an example of the risk analysis screen (individual) according to the embodiment. FIG. 15A illustrates an example of the switching tab region 203′, the KPI setting region 204′, and the information display region 205′ of the individual screen 200′. Since “Fatigue” (corresponding to “Fatigue crack” in FIG. 11) is selected in the switching tab region 203′, the individual screen 200′ of the risk analysis (fatigue crack) is displayed. In the information display region 205′, a risk is calculated using the index selected in the KPI setting region 204. The setting of the KPI setting region 204′ is common to the individual screen 200′. In the region 205A, a list of IDs of parts (column 205A1′), current risks (column 205A2′), future risks (column 205A3′), current damage levels (column 205A4′), and future damage levels (column 205A5′) is displayed. When a user selects a certain part, operation and maintenance measures, a prediction of fatigue crack propagation at the selected part, and a two-dimensional diagram and a three-dimensional diagram of a position at which the part is present are displayed in the region 205B′. For example, a rough position of the selected part is displayed in the region 205B3′ using a two-dimensional diagram of the marine vessel 1, and a detailed position is displayed in the region 205B4′ using a three-dimensional diagram. In the region 205B5′, a three-dimensional model diagram of the entirety of the marine vessel 1 is displayed, and the states of damages are displayed by color.

FIG. 15B illustrates enlarged views of the regions 205B1′ and 205B2′. In the region 205B1′, operation and maintenance measures, and a period, an area, and remarks for implementing the measures, and the like are displayed. In the region 205B2′, a graph of fatigue damage progress prediction is displayed. In the graph of the region 205B2′, the vertical axis represents fatigue damage level, and the horizontal axis represents time. The damage level and failure probability evaluation unit 14 performs prediction calculation of a fatigue damage level in consideration of variations in the material and the load of a target part, whereby a prediction having a width was illustrated is obtained. By using two types of thresholds, that is, a caution threshold value 205B6′ and a warning threshold value 205B7′, it is possible to grasp what level the fatigue damage will reach in the future.

FIG. 15C illustrates enlarged views of the same positions (respectively referred to as regions 205B1″ and 205B2″) when corrosion is selected in the switching tab region 203′. In the region 205B1″, operation and maintenance measures, and a period, an area, and remarks for implementing the measures, and the like are displayed. In the region 205B2″, a graph of corrosion progress prediction is displayed. In the graph of the region 205B2″, the vertical axis represents thinning amount and the horizontal axis represents time. The damage level and failure probability evaluation unit 14 predicts a thinning amount using the above equation (4). As in the case of the fatigue damage level, in order to provide a width of prediction, the upper and lower limits of a 99% interval (a curve u and a curve 1, respectively), a mean value (a curve m2), and a median value (a curve m1) are displayed. A user can grasp the tendency of the thinning amount of the target part in the future.

The individual screen 200′ may be provided with a function of displaying the FMEA 192, the test information 193, the design information 194, the manufacturing information 195, the analysis model 197, the maintenance history information 199, a photograph of an actual vessel, and the like relating to each part (for example, a call button for each information). A function of displaying the influence at the time of failure for each part from each viewpoint of cost, safety, environment, and production may be provided. In the individual screen 200′, the graphs illustrated in FIGS. 4 to 8 may be displayed.

### Sensor Information Screen

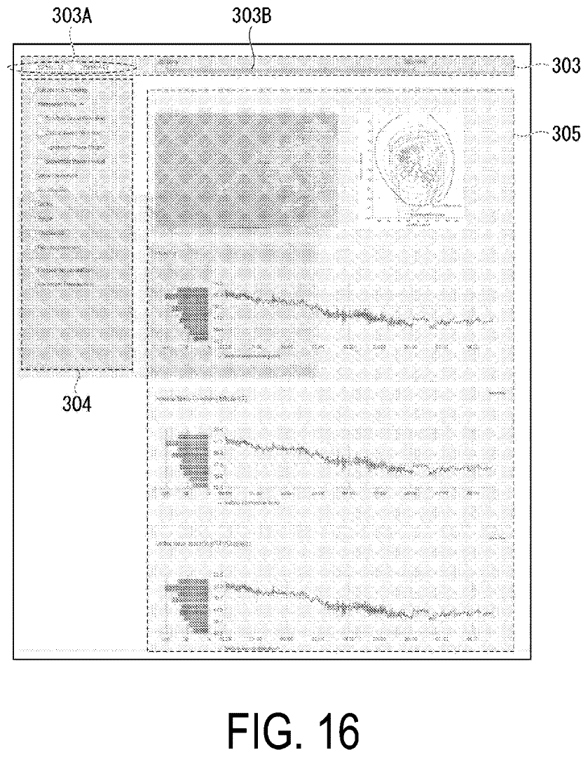

FIG. 16 is a diagram illustrating an example of the sensor information screen according to the embodiment. FIG. 16 illustrates an example of the period designation region 303, the display item selection region 304, and the information display region 305 of the sensor information screen 300. When a period is designated in a setting field 303A and an item to be displayed is selected in the display item selection region 304, the sensor information related to the selected display item in the designated period is displayed in the information display region 305. In the example of FIG. 16, time-series information (information in the period designated in the setting field 303A) of the position information, the travel direction, the wave height, and the wave direction of the marine vessel 1 is displayed.

### Effects

In monitoring a machine or equipment, it is desirable not only to perform abnormality determination by observing sensor information but also to perform risk management in consideration of a failure probability or a consequence degree at the time of failure of a target device. However, for example, in failure probability evaluation, there is a variety of failure modes such as fatigue, corrosion, wear, and creep depending on the design and service environment, which causes a complexity in the evaluation because a failure probability needs to be evaluated using a failure evaluation method and an evaluation model corresponding to each failure mode. In risk evaluation, various measures such as cost, safety (human damage), production loss, and influence on the environment may be used as the consequence degree at the time of failure. On the other hand, according to the present embodiment, it is possible to calculate a failure probability and a damage level for a failure mode corresponding to a part or a device to be evaluated. Consequence degrees can be calculated from the respective viewpoints of cost, safety, environment, and production. Then, the consequence degrees can be displayed together with the sensor information. Accordingly, a user can perform monitoring with reference to the damage evaluation and the risk evaluation of a monitoring target machine or the like. For each part and each failure mode, (1) failure probability and damage level, (2) failure consequence degree, (3) operation measure, (4) maintenance measure, and the like are evaluated, and, further, risk evaluation is performed as final evaluation. Further, at this time, since interim evaluation can be performed, that is, calculation results and the like obtained through the evaluation process of (1) failure probability and damage level, (2) failure consequence degree, (3) operation measure, and (4) maintenance measure can be displayed in various diagrams and graphs, and design information and the like can be accessed and displayed (for example, a function of calling and displaying the design information 194 from the individual screen 200′), it is possible to ensure transparency and consistency of the entire analysis. By visualizing the interim evaluation and ensuring the transparency and the consistency of the entire analysis including the final evaluation, it is possible to deepen the user's understanding of deterioration and damage of the machine or equipment to be monitored and to take flexible and appropriate measures.

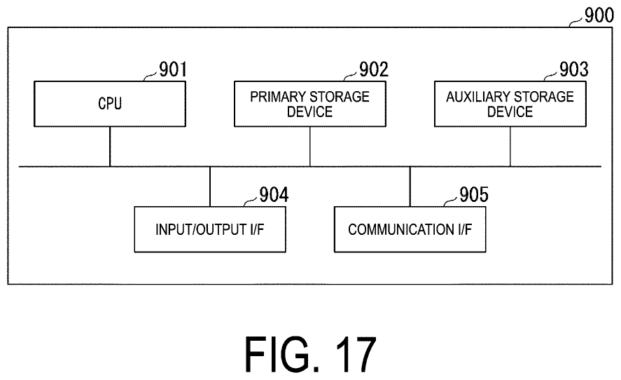

FIG. 17 is a diagram illustrating an example of a hardware configuration of the monitoring device according to the embodiment. A computer 900 includes a CPU 901, a primary storage device 902, an auxiliary storage device 903, an input/output interface 904, and a communication interface 905. The above-described monitoring device 10 is implemented in the computer 900. Each of the above-described functions is stored in the auxiliary storage device 903 in a format of a program. The CPU 901 reads the program from the auxiliary storage device 903, loads the program into the primary storage device 902, and executes the above-mentioned processing in accordance with the program. The CPU 901 secures a storage area in the primary storage device 902 in accordance with the program. The CPU 901 secures a storage area for storing data under processing in the auxiliary storage device 903 in accordance with the program.

Note that a program for implementing the whole or part of the functions of the monitoring device 10 may be recorded in a computer readable recording medium, and a computer system may be caused to read and execute the program that is recorded in the recording medium to execute the processing of respective functional units. The “computer system” here includes hardware such as an operating system (OS) or peripheral equipment. When a WWW system is used, the “computer system” also includes a home page provision environment (or a display environment). The “computer readable recording medium” refers to a portable medium such as a CD, a DVD, or a USB, or a storage device such as a hard disk built in the computer system. When the program is distributed to the computer 900 through a communication line, the computer 900 having received the distribution may load the program into the primary storage device 902 to execute the above-described processing. The above-described program may implement part of the above-described functions and may further implement the above-described functions in combination with a program already recorded in the computer system.

In the foregoing, some embodiments according to the present disclosure have been described, but all of these embodiments are merely illustrative and are not intended to limit the scope of the invention. These embodiments can be implemented in various other forms, and various omissions, substitutions, and changes can be made without departing from the gist of the invention. These embodiments and modifications thereof are included in the scope and gist of the invention and are also included in the scope of the invention described in the claims and the equivalents thereof.

### Supplementary Notes

The monitoring device, the display method, and the program described in each embodiment can be understood as follows, for example.

(1) A monitoring device 10 according to a first aspect includes: a sensor information acquisition unit 11 configured to acquire sensor information measured by a sensor; a damage level and failure probability evaluation unit 14 configured to calculate a failure probability (the failure probability includes a failure probability and a failure probability) or a damage level per part constituting a monitoring target (marine vessel 1) by using the sensor information; and a display control unit 18 configured to display the sensor information (the region 103A of FIG. 13A) and the failure probability or the damage level (the damage map of FIG. 13A and the like) of the part. This can grasp not only the sensor information affecting an evaluation target but also which part of the evaluation target is damaged.

(2) A monitoring device 10 according to a second aspect is the monitoring device of (1) and further includes a failure consequence evaluation unit 15 configured to calculate a consequence degree when the part fails (breakage includes the breakage and the failure described in paragraph 0013). The display control unit 18 displays the consequence degree when the part fails or a risk obtained by multiplying the consequence degree by the failure probability (the risk map of FIG. 14, the Pareto chart in the region 103G of FIG. 13A).

This can evaluate not only the damage level of the evaluation target but also the consequence degree and the risk at the time of failure.

(3) A monitoring device 10 according to a third aspect is the monitoring device of (2). The display unit displays a risk matrix (205B3 of FIG. 14B) indicating a correlation between the failure probability and the consequence degree of a plurality of the parts.

This can classify the parts in accordance with the failure probability and the degree of the risk, and grasp how many parts having a high degree of the risk exist among all the parts.

(4) A monitoring device 10 according to a fourth aspect is the monitoring device of any one of (1) to (3). The influence evaluation unit calculates at least one consequence degree of a degree of influence on safety, a degree of influence on environment, a degree of influence on production, or a degree of influence on cost, and the display control unit displays the at least one consequence degree calculated by the influence evaluation unit separately for each consequence degree.

This can grasp which of cost, safety, environment, and production is affected by the breakage or the failure of a part of interest.

(5) A monitoring device 10 according to a fifth aspect is the monitoring device of any one of (1) to (4). The damage level and failure probability evaluation unit calculates the damage level of the part in the future, and the display control unit displays the damage level of the part or the device at present and the damage level of the part or the device in the future.

This can predict what degree of damage will occur in the future (for example, at the time of the next maintenance and inspection), and to consider performing maintenance before breakage or failure, and the like.

(6) A monitoring device 10 according to a sixth aspect is the monitoring device of any one of (1) to (5) and further includes a measure calculation unit (an operation measure evaluation unit 16 and a maintenance measure evaluation unit 17) configured to calculate a measure related to operation or maintenance of the evaluation target against a damage of the part. The display control unit displays the measure related to operation or maintenance calculated by the measure calculation unit (FIG. 3, the region 103F of FIG. 13A, and the like).

This can grasp what kind of measure should be taken against the damage of a part or a device.

(7) A monitoring device 10 according to a seventh aspect is the monitoring device of any one of (1) to (6). The evaluation target is a marine vessel or a marine structure, the damage level and failure probability evaluation unit calculates a damage level of the part or the device per predetermined period due to a load received from ocean waves, and the display control unit displays the damage level of the part or the device for each predetermined period.

This can observe which part has accumulated damages on a daily basis.

(8) A monitoring device 10 according to an eighth aspect is the monitoring device of any one of (1) to (7). The damage level and failure probability evaluation unit sets a failure mode indicating a type of breakage for each part or each device and calculates, separately for the failure mode, the failure probability or the damage level of each part or each device.

This can optionally set and evaluate, for each part or device of the evaluation target, a type of breakage that may occur in the part or that needs to be monitored in the part, and thus to perform evaluation without omission.

(9) A display method according to a ninth aspect includes: a step of acquiring sensor information measured by a sensor; a step of calculating a failure probability or a damage level per part or device constituting an evaluation target by using the sensor information; and a step of displaying the sensor information and the failure probability or the damage level of the part or the device.

(10) A program according to a tenth aspect causes a computer to execute: a step of acquiring sensor information measured by a sensor; a step of calculating a failure probability or a damage level per part or device constituting an evaluation target by using the sensor information; and a step of displaying the sensor information and the failure probability or the damage level of the part or the device.

### Industrial Applicability

The monitoring device, the display method, and the program described above allows a failure probability or a damage level to be calculated and the calculated failure probability or the calculated damage level to be output.

### Reference Signs List

10 Monitoring device
11 Sensor information acquisition unit
12 Input unit
13 Control unit
14 Damage level and failure probability evaluation unit
15 Failure consequence evaluation unit
16 Operation measure evaluation unit
17 Maintenance measure evaluation unit
18 Display control unit
19 Storage unit
900 Computer
901 CPU
902 Primary storage device
903 Auxiliary storage device
904 Input/output interface
905 Communication interface

1. A monitoring device, comprising:
a sensor information acquisition unit configured to acquire sensor information measured by a sensor;
a damage level and failure probability evaluation unit configured to calculate a failure probability or a damage level per part or device constituting an evaluation target by using the sensor information; and
a display control unit configured to display the sensor information and the failure probability or the damage level of the part or the device.

2. The monitoring device according to claim 1, further comprising
a failure consequence evaluation unit configured to calculate a consequence degree when the part or the device fails, wherein
the display control unit displays the consequence degree when the part or the device fails or a risk obtained by multiplying the consequence degree by the failure probability.

3. The monitoring device according to claim 2, wherein the display control unit displays a risk matrix indicating a correlation between the failure probability and the consequence degree for a plurality of the parts or the devices.

4. The monitoring device according to claim 2, wherein
the failure consequence evaluation unit calculates at least one consequence degree of a degree of influence on safety, a degree of influence on environment, a degree of influence on production, or a degree of influence on cost, and
the display control unit displays the at least one consequence degree calculated by the failure consequence evaluation unit separately for each consequence degree.

5. The monitoring device according to claim 1, wherein
the damage level and failure probability evaluation unit calculates the damage level of the part or the device in the future, and
the display control unit displays the damage level of the part or the device at present and the damage level of the part or the device in the future.

6. The monitoring device according to claim 1, further comprising
a measure calculation unit configured to calculate a measure related to operation or maintenance of the evaluation target against a damage of the part, wherein
the display control unit displays the measure related to the operation or the maintenance calculated by the measure calculation unit.

7. The monitoring device according claim 1, wherein
the evaluation target is a marine vessel or a marine structure,
the damage level and failure probability evaluation unit calculates the damage level of the part or the device per predetermined period due to a load received from ocean waves, and
the display control unit displays the damage level of the part or the device for each predetermined period.

8. The monitoring device according to claim 1, wherein the damage level and failure probability evaluation unit sets a failure mode indicating a type of breakage for each part or each device and calculates, separately for the failure mode, the failure probability or the damage level of each part or each device.

9. A display method, comprising:
a step of acquiring sensor information measured by a sensor;
a step of calculating a failure probability or a damage level per part or device constituting an evaluation target by using the sensor information; and
a step of displaying the sensor information and the failure probability or the damage level of the part or the device.

10. A program causing a computer to execute:
a step of acquiring sensor information measured by a sensor;
a step of calculating a failure probability or a damage level per part or device constituting an evaluation target by using the sensor information; and
a step of displaying the sensor information and the failure probability or the damage level of the part or the device.
